(19) United States
(12) Patent Application Publication
(10) Pub. No.: US 2020/0150656 A1
(43) Pub. Date: May 14, 2020

(54) Autonomous Trucks with Specialized Behaviors for Mining and Construction Applications

(71) Applicant: Robotic Research, LLC, Gaithersburg, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/601,775

(22) Filed: Oct. 15, 2019

Related U.S. Application Data
(60) Provisional application No. 62/759,948, filed on Nov. 12, 2018.

(51) Int. Cl. G05D 1/00; G05D 1/02

(52) U.S. Cl. CPC G05D 1/0088; G05D 1/0214; G05D 1/0242; G05D 2201/0202; G05D 1/0257; G05D 1/0287; G05D 1/0246

(57) ABSTRACT

The system in this invention is autonomous control for these trucks covering a variety of behaviors specific to mining applications. The invention uses these behaviors to increase the efficiency and safety of running a mining operation, while also reducing cost. This invention involves the development of a system that is designed to increase the safely of mining and construction autonomous trucks. This system is comprised of one or more sensors that can detect road features, a drive-by-wire kit installed on a truck, an autonomous driver that creates the trajectories which take the vehicle from a starting location to an ending location (final destination), while at the same time implementing one or more of the behaviors mentioned below. One behavior implemented by the system is varying the trajectory within the traversable road to minimize the ruts. Another behavior is purposely driving over the “high” points of the support surface to flatten the ruts. Also, the system can purposely avoid (or stop the vehicle) if a sharp object is detected on the route that can possibly puncture the tire. It can detect debris that has been dropped from the truck, to alert other vehicles or itself when driven along the same route. The system can also detect and historically track features in the road to determine road movement, and therefore alert to possible collapses or landslides. Finally, the system can also implement stopping the vehicle, or avoiding deep water puddles, detected by comparing the water surface and the pre-recorded support surface from a previous pass.

### CROSS REFERENCE TO RELATED PATENT APPLICATIONS

This application claims priority from U.S. Patent Application Ser. No. 62/759,948, entitled “Autonomous Trucks with Specialized Behaviors for Mining and Construction Applications”, filed on 12 Nov. 2019. The benefit under 35 USC § 119(e) of the United States provisional application is hereby claimed, and the aforementioned application is hereby incorporated herein by reference.

### STATEMENT REGARDING FEDERAL SPONSORSHIP

No part of this invention was a result of any federally sponsored research.

### TECHNICAL FIELD OF THE INVENTION

The present invention relates in general to autonomous systems, and, more specifically, to autonomous trucks with specialized behaviors for mining and construction applications.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Given the state-of-the-art in robotics, many mmmg applications are prime candidates for robotic automation. For example, many mining and construction applications require that trucks transport dirt, ore, or other matter from one location to another. This is usually performed using trucks equipped with loaders or excavators. The trucks take those loads and generally deposit them in piles, which are then used for the next step of the mining process. The system in this invention is autonomous control for these trucks covering a variety of behaviors specific to mining applications. The invention uses these behaviors to increase the efficiency and safety of running a mining operation, while also reducing cost.

### SUMMARY OF THE INVENTION

To minimize the limitations in the prior art, and to minimize other limitations that will be apparent upon reading and understanding the present specification, the present invention describes autonomous trucks with specialized behaviors for mining and construction applications.

These and other advantages and features of the present invention are described herein with specificity so as to make the present invention understandable to one of ordinary skill in the art, both with respect to how to practice the present invention and how to make the present invention.

The present invention describes the development of a system that is designed to increase the safety of mining and construction autonomous trucks. This system is comprised of one or more sensors, a drive-by-wire kit, and autonomous driver that creates trajectories from a starting location to a final destination while also implementing a variety of different behaviors.

Some examples of behaviors that are implemented by the system include varying the trajectory within the traversable road to minimize the ruts, purposely driving over the “high” points of the support surface to flatten the ruts, purposely avoiding (or stopping the vehicle) if a sharp object is detected on the route that can possibly puncture the tires, detecting debris that has been dropped from the truck, to alert other vehicles or itself when driven along the same route, detecting and historically tracking features in the road to determine road movement, and therefore alert to possible collapses or landslides, and stopping the vehicle, or avoiding deep water puddles that are detected by comparing the water surface and the pre-recorded support surface from a previous pass.

### BRIEF DESCRIPTION OF THE DRAWINGS

FIG. 1 shows the basic system for the autonomous trucks with specialized behaviors for mining and construction.

FIG. 2A shows the first pass in softer terrain where the vehicle drives in in the same tire tracks and FIGS. 2B and 2C show that the ruts get deeper with each additional pass through the same tire tracks.

FIG. 3A-C show that by varying the path of the vehicle laterally, the effect of rutting can be reduced, and more trips can be made before requiring road grading.

FIG. 4 shows that the vehicle detects hazards such as sharp objects and spills and these hazards are avoided by stopping or driving around while staying in the allowable road width.

### DETAILED DESCRIPTION OF THE INVENTION

Mining trucks in this invention would have a drive-by-wire kit and an autonomy kit. The drive-by-wire kit, abbreviated “B-kit”, is a set of actuators that allow computer control of the basic functionality of the truck: steering, brake, acceleration, and gear shifting. The autonomy kit, abbreviated “A-kit”, creates and follows trajectories that are sent to the B-kit. These trajectories take the truck from its initial pose to the desired pose. These trajectories are obstacle free and avoid pedestrians.

Within the invention's proposed A-Kit, there are some mining-specific behaviors which differentiate it from a standard A-Kit. These include:

As the trucks transport their load from one location to another, they create ruts on the path. These ruts deepen as more trucks traverse them. At some point, the ruts become so deep that they create a hazard, whereby the vehicles can drag the undercarriage, hit center, and ultimately become stuck the ruts. The proposed invention purposely randomizes the trajectories of the trucks to minimize rut generation. In particular, the system within user set margins can purposely select higher level areas on the road to minimize rut generation and the resulting road maintenance.

Even with the randomization of the trajectories, at some point, depending on the composition of the road, roads will deteriorate past the point where even randomized behavior will not be sufficient to prevent ruts. The invention is constantly monitoring the conditions of these roads and creates reports that can be used to determine where it is necessary to regrade, how much material is needed to fill in the ruts, how much material will need to be removed/moved to re-level the road, and how long will it take to relevel the road.

The walls that create the storage bay for trucks used for mining (and in some cases for construction), are usually low. This is to simplify the process of loading the truck. Unfortunately, in many situations, the lower walls cause trucks to drop debris. This debris could be composed of shards and rocks that can easily shred the tires of the next truck. For this application, one important task that truck drivers do is protecting the tires from damage. These truck tires are expensive, and the process of switching them is tedious and time-consuming. The invention verifies that the roads are clean from debris in two ways, by visual/ladar sensing of the road for debris dropped by other vehicles or from natural causes, specifically looking for sharp or hazardous objects, and by visual/ladar sensing of rocks or debris falling off the current truck. Even though these rocks may not pose a danger to the current truck, they may harm the next vehicle traversing the area, or they may harm the same vehicle as it drives on the same road at a later point.

By measuring changes in the weight of the load, thereby deciding if rocks or other debris is being dropped. This is accomplished by measuring the overall weight on all four wheels, using a combination of strain gauges and inertial components.

In many areas where mining is performed, roads are hastily made, and are not designed to be permanent structures or transportation features. Therefore, the material used for building the roads, and the surface of the road, is usually of a different composition than a road created for public use. Because the A-kit has a navigation system that can be very accurate, the invention can measure movements on the surface that may predict possible unstable soil that can lead to landslides. Landslides are one of the more dangerous occurrences in the mining world and can cause serious damage, even claiming lives. The invention uses features on the road to determine terrain movement. These features could be naturally occurring (like fallen tree trunks) or they can be added as part of the road construction (marker sticks, cones, etc.). These markers are tracked over time by the truck, and the invention is capable of sharing the location of the markers across multiple machines (trucks).

The invention is composed of three main modules:

A perception system that uses a combination of cameras, stereo pairs, LADAR, and/or ranging sensors that collect imagery in the areas where the truck will traverse. The perception system also has a navigation unit. The navigation unit may include GPS, inertial components, ranging radios, wheel encoders, and/or strain gauges. The perception system processes the information collected by the sensors to create a support surface estimation. This support surface is an estimate of the location of where the wheel-soil interaction will occur. It also uses the support surface to detect the ruts as indentations in the road. The ruts are determined as longitudinal negative features along the road that are below the average grade of the road (or the designed grade of the road). It also monitors the weight of the overall truck to determine if any debris has been dropped).

Given the support surface, finds protruding debris matches a pattern that could slash tires. These are usually rocks of a certain size that have linear or angular features, which are determined by the system to be capable of penetrating the tires. This special class of debris is detected using the LDADAR (or stereo pair), which classifies objects using a morphological template, or using the cameras and a Deep Learning training set. The cameras are used to classify the type of material that this debris may be composed of using color and texture.

Finds the location of features en route, which are then used to compare the movement of the road, to predict the possibility of landslides.

Determines the areas of the road that are traversable and decides a margin to be used by the planner to randomize the trajectory.

Detects puddles. The LADAR and camera cannot penetrate the dirty water that usually make up most puddles on mining and construction routes. Therefore, in areas where there is water, the support surface algorithms measure the surface of water, rather than the depths of a puddle where the soil-wheel interaction will occur. The depth of the puddle is measured by the perception system as the difference from the surface of the water detected by the LADAR, and the depth at which the wheels of the truck sink.

Finally, the perception system finds all obstacles that can harm the vehicle and sends these obstacles to the planning system.

A world model system that stores and collects the above information over the complete trajectory and historically as the same road is traversed. The world model is shared by different trucks using a radio, or physically shared. The information collected includes road width, rut locations, features along the road, support surface estimation, and obstacles.

A behavior generation module. The behavior generation module creates obstacle-free trajectories that take the vehicle from the starting location to the final location. The behavior generator uses the information supplied by the world model. The behavior generator module can randomize the trajectories within the tolerances of the road, taking into consideration road width, obstacles, the support surface, and traffic. The behavior generation module can also purposely drive the vehicle over the “high points” of the support surface as part of the rut minimization trajectory generation. The behavior generation module may also stop the vehicle from going into areas where the water surface measured from the LADAR and the previously recorded support surface, creates areas that are too deep to ford.

This invention describes the development of a system that is designed to increase the safety of mining and construction autonomous trucks. This system comprises one or more sensors that can detect road features, a drive-by-wire kit installed on a truck, an autonomous driver that creates trajectories which take the vehicle from a starting location to an ending location (final destination), while at the same time implementing one or more of the behaviors listed below.

Here is a summary of the different behaviors that are implemented by the system. One behavior involves varying the trajectory within the traversable road to minimize the ruts. Another involves purposely driving over the “high” points of the support surface to flatten the ruts. The system can also purposely avoid (or stop the vehicle) if a sharp object is detected on the route that can possibly puncture the tires. It can also detect debris that has been dropped from the truck to alert other vehicles or itself when driven along the same route. Another behavior the system implements is detecting and historically tracking features in the road to determine road movement, and therefore alert to possible collapses or landslides. Also, it can stop the vehicle or avoid deep water puddles that are detected by comparing the water surface and the pre-recorded support surf ace from a previous pass.

Instead of using cables, hydraulic pressure, and other ways of providing a driver with direct, physical control over the speed or direction of a vehicle, drive-by-wire technology uses electronic controls to activate the brakes, control the steering, and operate other systems.

The system has a perception module that uses a LADAR, a stereo pair, a RADAR, a daylight camera, an infrared camera, and/or any combination of these.

The perception module (PM) is a scientific instrument to explore and demonstrate binocular machine vision. The perception module's purpose is to capture binocular imagery data from an articulated camera pair and transform that information into distance estimates in a retino-centric reference frame. The perception module was designed to be cost-effective, light, and robust; suitable for inclusion on military robotics and scientific experiments. The module's potential application is widespread, and it could be mounted to many platform types.

Laser Detection and Ranging (LADAR) is a surveying method that measures distance to a target by illuminating the target with laser light and measuring the reflected light with a sensor. Differences in laser return times and wavelengths can then be used to make digital 3-D representations of the target.

A stereo pair is a pair of flat perspective images of the same object obtained from different points of view. When a stereopair is viewed in such a way that each eye sees only one of the images, a three-dimensional (stereoscopic) picture giving a sensation of depth is perceived.

Radio Detection and Ranging (RADAR) is a detection system that uses radio waves to determine the range, angle, or velocity of objects. It can be used to detect aircraft, ships, spacecraft, guided missiles, motor vehicles, weather formations, and terrain.

A daylight camera involves the mode for the normal daylight setting while shooting outdoors.

An infrared camera is a non-contact device that detects infrared energy (heat) and converts it into an electronic signal, which is then processed to produce a thermal image on a video monitor and perform temperature calculations. A thermographic camera is a device that forms a heat zone image using infrared radiation, similar to a common camera that forms an image using visible light. Instead of the 400-700 nanometer range of the visible light camera, infrared cameras operate in wavelengths as long as 14,000 nm.

The detected features stored in the world model are shared by multiple vehicles. The world model system stores and collects different types of information over the complete trajectory and historically as the same road is traversed. Some examples of different types of information that the world model stores and collects include finding protruding debris that matches a pattern that could slash tires, finding the location of features en route, which are then used to compare the movement of the road, to predict the possibility of landslides, determining the areas of the road that are traversable, deciding a margin to be used by the planner to randomize the trajectory, detecting puddles, and finding all obstacles that can harm the vehicle and sending these obstacles to the planning system.

A road grader or operator is automatically summoned when the ruts become too large to traverse, or above a certain threshold. A road grader is a construction machine with a long blade used to create a flat surface during the grading process.

In this system, an operator is summoned if the features on the road have moved above a certain threshold which could indicate that the road could be prone to collapse or landslide. Landslide refers to the sliding down of a mass of earth or rock.

In this system, an operator is summoned if a sharp object that can tear the tires is found, even if it can be avoided by the “A-kit”. The A-kit is the abbreviation for autonomy kit, and it follows trajectories that are sent to the “B-kit” which is the drive-by-wire kit.

In this system, an operator is summoned if a certain threshold weight has been dropped from the truck. The system is also comprised of a radio for transmitting information of the road conditions to other systems that are equipped with the invention, or a centralized monitoring system. A centralized monitoring system is a system where the information of the road conditions that are transmitted by the radio are stored. This is like the main headquarters for the storage of the information that is collected.

In this system, the raw sensors are on the vehicle, but some of the feature extraction and behavior generation algorithms are located outside the truck.

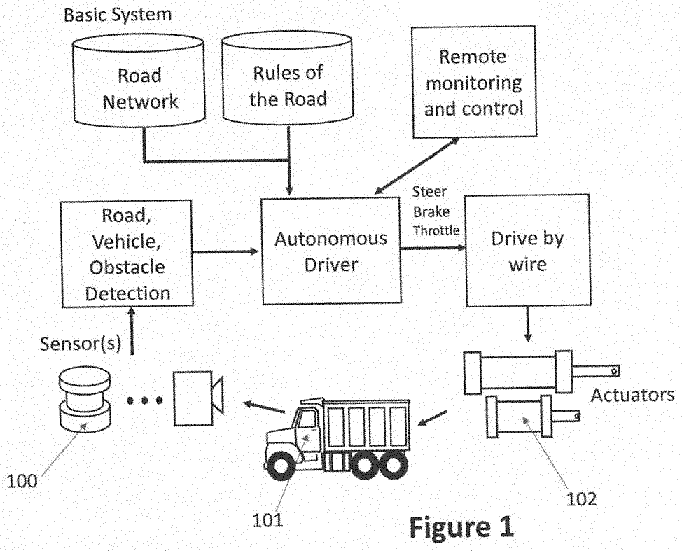

FIG. 1 shows the overall basic system of the autonomous trucks that have specialized behaviors for mining and construction applications. It shows the sensors (100) detecting the road, vehicle, and obstacles and passing on the information to the autonomous driver. The autonomous driver receives information on the road network and the rules of the road from the database. There is also remote monitoring and control by the autonomous driver. The autonomous driver is connected to a drive-by-wire kit which controls the steering, brake, and throttle and this leads to the actuators (102). This then leads to the autonomous truck (101) which also goes to the sensors.

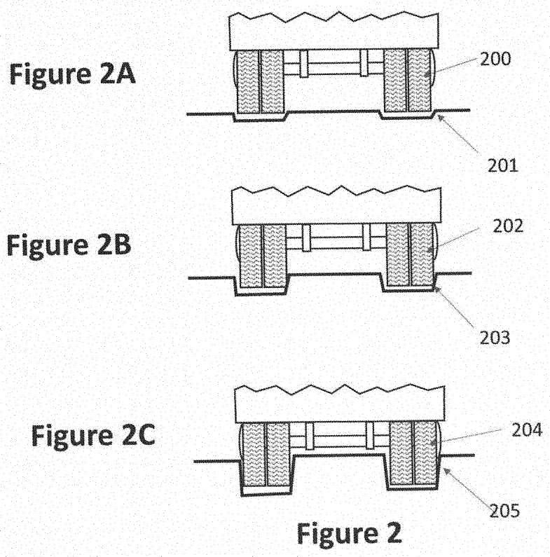

FIG. 2A shows that there is a rut (201) that is created by the tires (200) on the softer terrain after the tires drive in the same tire tracks in a pass over this terrain. In the case of FIG. 2B, after an additional pass over the softer terrain in which the tires (202) drive in the same tire tracks, the rut (203) becomes deeper than after the first pass shown in FIG. 2A. In the case of FIG. 2C, after the third pass through the same tire tracks in the softer terrain, the tires (204) create an even deeper rut (205) in the terrain compared to that which is created during the first pass or second pass in FIG. 2A or FIG. 2B.

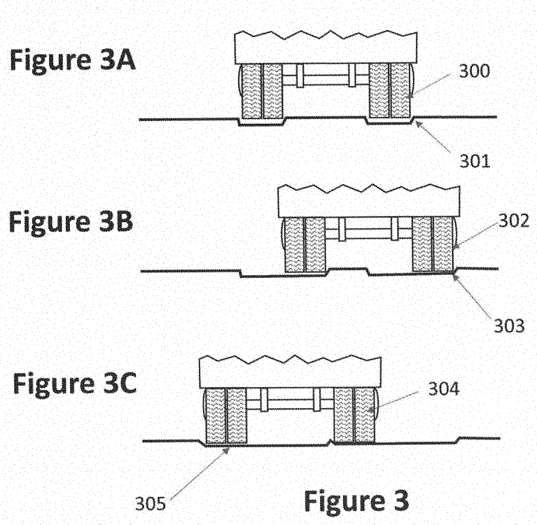

FIG. 3A shows the vehicle's tires (300) taking a first pass through the tire tracks and creating a rut (301) similar to that which can be seen in FIG. 2A. FIG. 3B and FIG. 3C show that by varying the path of the vehicle laterally, the effect of rutting can be reduced, and more trips can be made before requiring road grading. The lateral offsets must keep the vehicle inside the allowable road width. In FIG. 3B, it can be seen that the path of the vehicle is to the right compared to the original path shown in FIG. 3A. Here, the tires (302) follow a new path to the right of the original path, which greatly minimizes the formation of ruts (303). In FIG. 3C, it can be seen that the path of the vehicle is to the left compared to the original path shown in FIG. 3A. Here, the tires (304) follow a new path to the left of the original path, which again also greatly minimizes the formation of ruts (305).

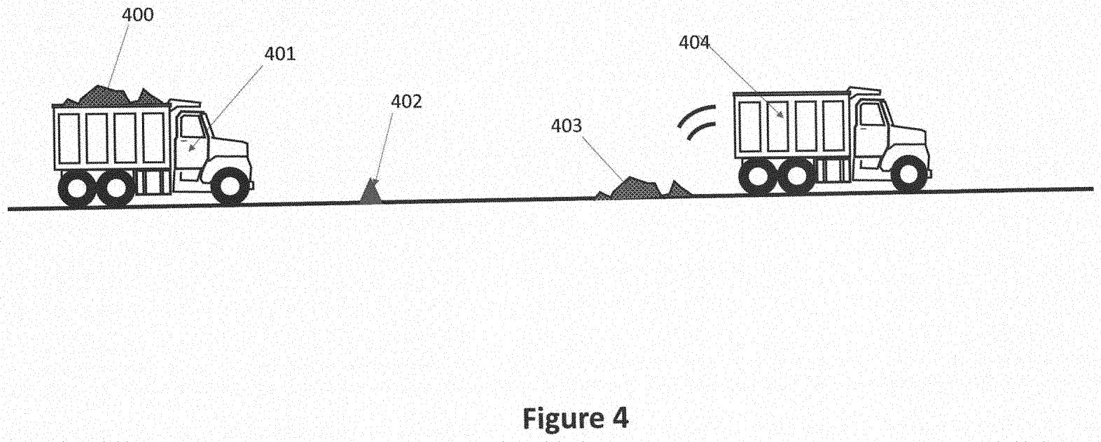

FIG. 4 shows the vehicle detecting hazards such as sharp objects and spills on the road. It can be seen that there is a triangle shaped sharp object, which is a hazard (402), which is on the road that the autonomous truck (401) carrying materials (400) and also there is a spill (403) in which the contents from the autonomous truck (401) have fell off the truck. The autonomous truck (401) avoids the hazards by stopping or driving around the hazard (402) while staying in the allowable road width. The vehicle (401) may also warn other vehicles about the hazards (402).

The embodiments of the invention in which an exclusive property or privilege is claimed are defined as follows:

1. A system to increase the safety of mining and construction autonomous trucks, composed of:
a. One or more sensors that can detect road features;
b. A drive-by-wire kit installed on a truck;
c. An autonomous driver that creates trajectories which take the vehicle from a starting location to an ending location (final destination), while at the same time implementing one or more of the following behaviors:
1. Varying the trajectory within the traversable road to minimize the ruts;
11. Purposely driving over the “high” points of the support surface to flatten the ruts;
111. Purposely avoiding (or stopping the vehicle) if a sharp object is detected on the route that can possibly puncture the tires;
1v. Detecting debris that has been dropped from the truck, to alert other vehicles or itself when driven along the same route;
v. Detecting and historically tracking features in the road to determine road movement, and therefore alert to possible collapses or landslides;
v1. Stopping the vehicle, or avoiding deep water puddles, detected by comparing the water surface and the pre-recorded support surface from a previous pass.

2. The system in 1, where the perception module uses a LADAR, a stereo pair, a

3. RADAR, a daylight camera, an infrared camera, and or any combination of these.

4. The system in claim 1, where the detected features stored in the world model are shared by multiple vehicles.

5. The system in claim 1, where a road grader or operator is automatically summoned when the ruts become too large to traverse, or above a certain threshold.

6. The system in claim 1, where a road grader or operator is automatically summoned if the water puddles are too deep to traverse, or deeper than a certain threshold.

7. The system in claim 1, where an operator is summoned if the features on the road have moved above a certain threshold (which may indicate that the road could be prone to collapse or landslide).

8. The system in claim 1, where an operator is summoned if a sharp object that can tear the tires is found, even if it can be avoided by the A-kit.

9. The system in claim 1, where an operator is summoned if a certain threshold weight has been dropped from the truck.

10. The system in claim 1, further composed of a radio for transmitting information of the road conditions to other systems equipped with the invention, or a centralized monitoring system.

11. The system in claim 1, where the raw sensors are on the vehicle, but some of the feature extraction and behavior generation algorithms are located outside of the truck.
